(19) United States
(12) Patent Application Publication
(10) Pub. No.: US 2009/0072541 A1
(43) Pub. Date: Mar. 19, 2009

(54) AIR DRIVEN FAN GENERATOR SYSTEM

(76) Inventor: Hendrick Cornelius Van Harselaar, Queensland (AU)

Correspondence Address: EDWIN D. SCHINDLER, FIVE HIRSCH AVENUE, P.O. BOX 966, CORAM, NY, 11727-0966, US

(21) Appl. No.: 11/718,631

(22) PCT Filed: Nov. 9, 2005
(86) PCT No.: PCT/AU2005/001704

§ 371 Date: Aug. 20, 2008

(30) Foreign Application Priority Data
Nov. 9, 2004 (AU) 2004906440

(51) Int. Cl. F03D 9/00; F04D 25/08

(52) U.S. Cl. 290/54; 417/336

(57) ABSTRACT

An air driven fan generator system includes, in association with a fan, a secondary fan, which is mounted coaxially with the fan and with the blades of the secondary fan being relatively closed to the blades of the fan. A generator device is associated with the secondary fan, so that power can be generated by the rotation of the secondary fan due to the movement of the air being passed through the fan. The secondary fan may have the same number, or a lesser number, of blades as the fan, and the pitch of these blades can be such as to provide the required output.

### TECHNICAL AREA

This invention relates to an electrical system and, in particular, to a system for generating power from the inlets to or outlets from fans which are already carrying out other operations.

### BACKGROUND TO THE INVENTION

In buildings there are often a multiplicity of large and small capacity fans; such fans being located in exhaust systems, air distribution systems, generally associated with air-conditioning, cooling towers and the like, and heat exchangers. These fans can, for example, be located at air inlets from which air is driven through duct-work to the interior of the building and which may or may not be associated with air-conditioning or heating of cooling systems or outlets which may be either air outlets from the building or outlet from particular areas which may feed into main outlet ducts.

### OUTLINE OF THE INVENTION

In this specification, purely for simplicity, we will refer to exhaust fans, when we use the word “fans”, and will describe the invention in relation to exhaust fans, but this is not deemed to be in any way limiting.

The object of the invention is to provide a means which can be associated with an already existing fan to obtain the benefit of energy in the fluid passing through the fan, without adding to the cost of operation of the fan.

The invention includes, in its broadest sense, in association with a fan, a secondary fan which is mounted coaxial with the fan and with the blades relatively close to the blades of the fan and generator means associated with the secondary fan whereby power can be generated by the rotation of the secondary fan due to the air being passed through the fan.

In one particular form of the invention, the blades of the secondary fan are located in the opposite sense to the blades of the fan, so that on air striking the secondary fan, it will cause rotation of the secondary fan in the same direction of that of the fan.

In a preferred embodiment of the invention, the secondary fan is provided with a smaller number of blades than the fan.

In another aspect of the invention, the secondary fan is not provided with a load but it permitted to be free running.

### DESCRIPTION OF AN EMBODIMENT OF THE INVENTION

In order that the invention may be more readily understood, reference will be made to the accompanying drawings, in which:

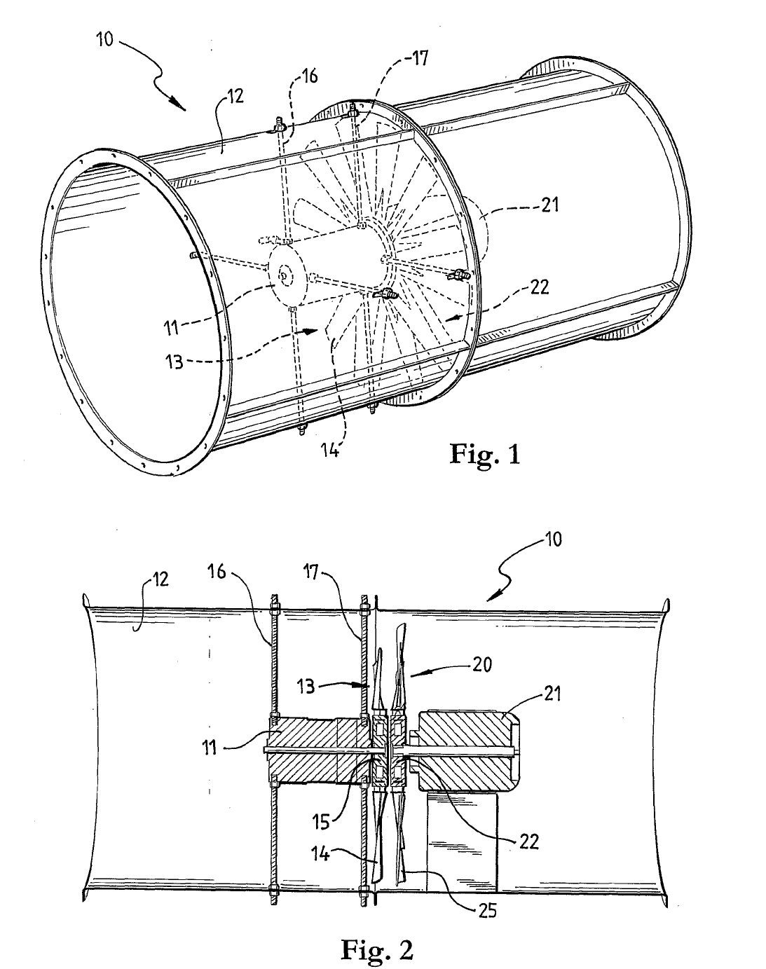

FIG. 1 shows a perspective view of a duct which has located therein an exhaust fan and a secondary fan of the invention;

FIG. 2 shows a longitudinal section through the duct which includes an exhaust fan and also the secondary fan of the invention;

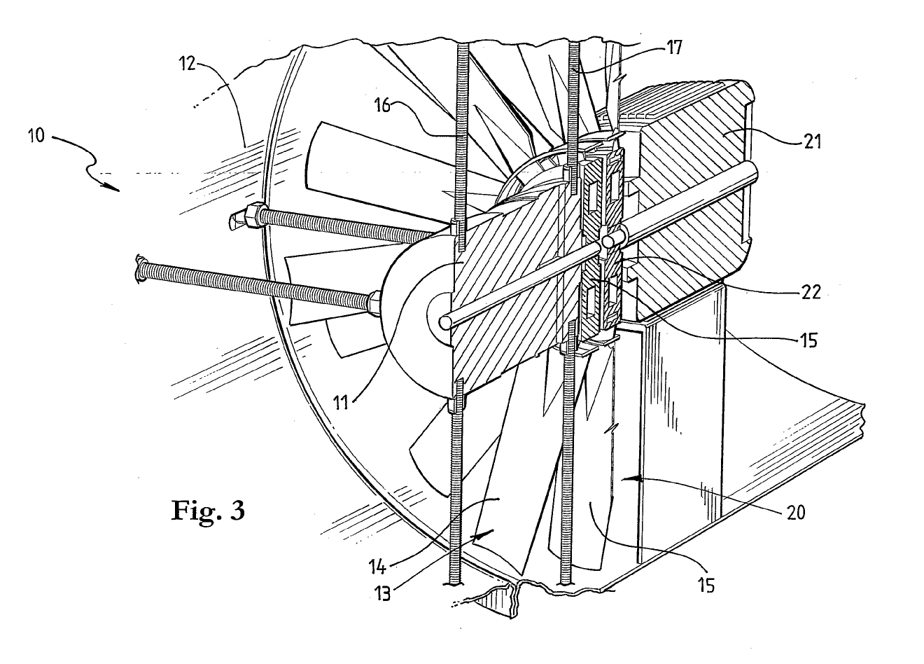

FIG. 3 shows an enlarged, broken, perspective of the exhaust fan and the secondary fan in the duct; and

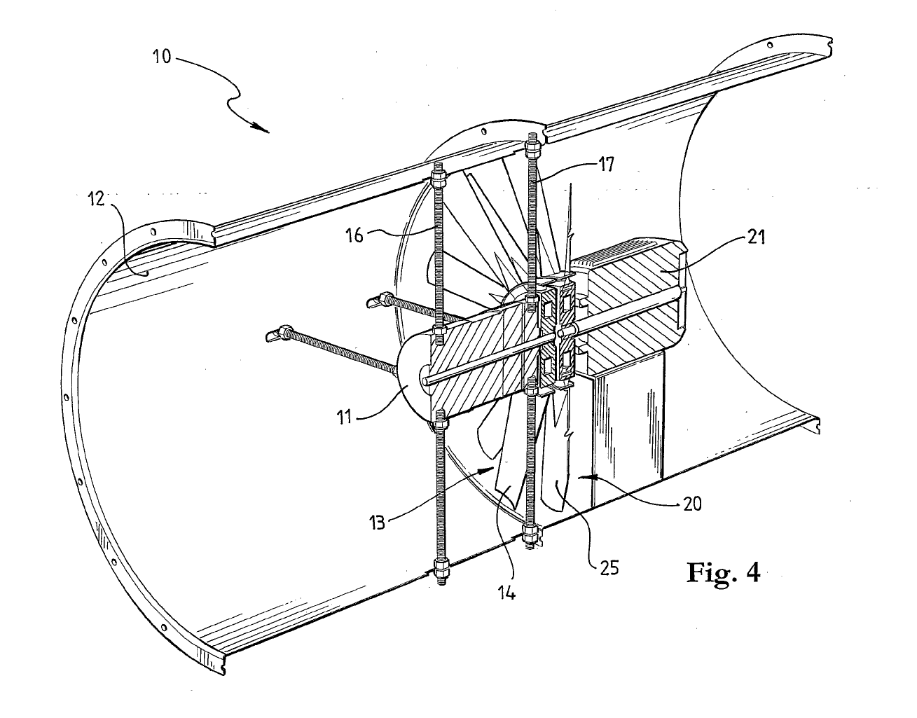

FIG. 4 shows a broken perspective of the arrangement.

The invention is applicable to fans of most sizes and, depending upon the particular size so, expectedly, the output of the invention will vary, and the applications can vary.

In a first embodiment, which is exemplified in FIGS. 1 to 4, the invention is applied to a fan 10 having 4 horse-power motor 11 located in a 500 mm cylindrical duct or casing 12 with a twelve bladed fan 13, the blades 14 of which extend close to the interior surface of the casing 12. This fan is located in ductwork to provide an exhaust fan for a medium or small-sized commercial building.

The fan and generator can be foot mounted within an integral duct which can be connected to the remainder of the ductwork or, alternatively, can be supported by rods or the like 16,17 which extend between the fan body of the wall of the duct 12.

The blades 14 which are located about the periphery of a hub 15 may have a pitch of 30°.

When connected to a normal reticulated electric 240 volt supply, the fan 10 has been tested when operating and these tests show that the fan uses 5.3 amps of current.

The fan 10 may be located some distance within the duct relative to the external wall to which the duct extends to release air to the atmosphere, although it could be located closely adjacent the outlet at the external wall.

If it is located inwardly, then the secondary fan 20 and generator 21 of the invention may be located in the ductwork with the outer face of the hub 22 closely adjacent that of the hub 15 of the exhaust fan.

Preferably, the hubs 15,22 may both have relatively flat outwardly directed surfaces. The separation can be as little as 4-6 mm up to 120 mm or more, depending on the output required.

It is also preferred that the hubs be of the same diameter, but even if they are not of the same diameter, the invention still gives good results.

Of course, if the blades of either fan extend forwardly beyond the hub, then the location must be so that there is at least an equivalent spacing between outwardly extending edges of the fan blades.

The secondary fan 20 may have between four blades and the number of blades of the exhaust fan, although that is not limiting, and have a pitch opposite to the pitch of the fan. These blades are preferably made of metal, although they could be made of an engineering grade plastic, and they also preferably have a size similar to the size of the blade on the fan, but they can be smaller

When the exhaust fan 10 is in operation the air passing through its fan blades strikes the blades of the secondary fan which causes this to rotate, causing rotation of the generator 21 attached thereto.

The blades 25 of the secondary fan/generator 20 accelerate so that there is optimum transfer of the energy from the inlet air of the exhaust fan. The generator can be caused to rotate a different speeds depending on the pitch of the blades of the fan generator and the spacing between the blades of the fan and those of the generator. This drives the generator at the required speed to provide the required output voltage and frequency, normally either 240V at 50 Hz or 110V at 60 Hz.

In this embodiment, the exhaust fan motor which nominally has a maximum rating of 5.7 amps, ran at 5.3 amps with the secondary fan driving the generator both when loaded and unloaded.

The generator was a nominal 1500 watt two-pole generator and the tests carried out by an external engineer showed that the generator could produce 540 watts into a load and examination of the current drawn by the exhaust fan shows that this was consistent at 5.3 amps, whether the generator was loaded or unloaded.

Thus, there was apparently no cost in the operation of the device of the invention.

In a second embodiment of the invention where there was a ten horse-power motor located in an 800 mm casing, measurements under test conditions of the current drawn by the exhaust fan from the building did not vary from 9.9 amps, regardless of the changed loading, due to the existence of the secondary fan.

On separate tests we obtained the following results from the generator:—
1135 watts @ 244.6 volts and 50 Hz;
1160 watts @ 240 volts and 50 Hz; and
1180 watts @ 236.4 volts and 50 Hz.

In this case, the fan had 12 blades and the generator had six blades. Again, we found that once the fan came up to speed, bringing the ancillary fan to speed, we got the output from the generator, as stated above.

In this larger diameter version the fan may have ten or twelve blades and the generator may have the same number or fewer blades. In practice, I have found satisfactorily results when the generator has approximately half the number of blades as the fan.

It has been found in each case that when both the fans are both operating effectively, that there was no increase in turbulence in the output airflow, and, as mentioned above, the power usage of the fan did not appear to vary whilst, at the same time, there was a substantial power output from the secondary fan.

A further aspect which has been noted is that when the secondary fan is not loaded by a generator, the actual load on the exhaust fan appears to diminish and the actual power load of the exhaust fan appears to reduce so that it actually operates more efficiently when there is a secondary fan in position, which is carrying no load

Whilst there has been described the use of the invention in association with fan motors of reasonably substantial size, it will be appreciated that the invention can also be used with lower powered fan motors.

Again, referring to an exhaust system, whilst there are the major exhaust fans, of the type referred to, which draw air through ducting and delivered to the outside of the building, there may also be a number of smaller fans which draw air from areas to the ducting from which the air is drawn by the exhaust fans.

For example, in a large building, each toilet area and kitchen may be provided with an exhaust fan by means of which air is drawn from the area being served, and then to the duct where the air is being substantially moved by the larger exhaust fans previously discussed.

There are also applications, such as roof ventilation fans where the fans are located close to or at an aperture through a roof so that the air in the roof space can be evacuated and replaced from gaps or spaces around the roof and a secondary fan of the invention can be associated with such a fan. Also, there can be fixes applications in buildings where there are small fans operating some or all of the time, and the invention can also be applied to these.

For example, there are applications where constant low powered current may be required, for example, maintaining the batteries in emergency lights and exit lights.

These are often operated by DC accumulators and whilst some, such as exit lights, may be normally lit others, such as emergency lights may normally be not lit, but are lit if there is any power break-down.

The invention is particularly suitable for simply maintaining a trickle charge into the batteries of such lights whenever the fan in the area is being operated.

I have described the particular invention in relation to exhaust fans, but it will be appreciated that the invention can be applied to other applications where fans are being used, such as air inlet; it can also be used in heat exchangers, where fans may be continually causing air to pass through a radiator, or the like, to remove heat from fluids carried therein and passed to waste, or in air heating and/or cooling system where the object is to heat and/or cool the air.

It is preferred that both the fan and the generator, which would be located on opposite sides of the radiator, are ducted to permit optimum transmission of the air from the fan through the radiator to the generator, some value can be achieved from the invention, even where there is no specific constraint on the air passing through the radiator.

1-7. (canceled)

8. An air driven fan generator system, comprising:
a primary fan having a plurality of blades;
a secondary fan coaxially mounted with said primary fan and having a plurality of blades in close proximity to said plurality of blades of said primary fan; and
means for generating electrical power for said secondary fan by generating power via rotation of said plurality of blades of said secondary fan due to air being passed through said primary fan.

9. The air driven fan generator system according to claim 8, wherein said plurality of blades of said secondary fan are positioned oppositely relative to said plurality of blades of said primary fan, so that air striking said secondary fan will cause rotation of said plurality of blades of said secondary fan in a same direction as that of said primary fan.

10. The air driven fan system according to claim 8, wherein said plurality of blades of said secondary fan is a lesser number of blades than said plurality of blades of said primary fan.

11. The air driven fan generator system according to claim 8, wherein said plurality of blades of said secondary fan is equal in number to said plurality of blades of said primary fan.

12. The air driven fan generator system according to claim 8, wherein said secondary fan is a free running fan.
